(19) United States
(12) Patent Application Publication
(10) Pub. No.: US 2025/0246831 A1
(43) Pub. Date: Jul. 31, 2025

(54) METHODS AND APPARATUS TO IMPROVE RELIABILITY OF ELECTRICAL SIGNALS ACROSS A CIRCUIT BOARD

(71) Applicant: Intel Corporation, Santa Clara, CA (US)

(72) Inventor: Landon Hanks, Milwaukie, OR (US)

(73) Assignee: Intel Corporation, Santa Clara, CA (US)

(21) Appl. No.: 19/179,810

(22) Filed: Apr. 15, 2025

(51) Int. Cl. H01R 12/73; H01R 13/115

(52) U.S. Cl. CPC H01R 12/737; H01R 13/115

(57) ABSTRACT

Methods and apparatus to improve reliability of electrical signals across a circuit board are disclosed. An example apparatus includes a housing defining a slot to receive a first circuit board, the housing proximate a surface of a second circuit board, and a conductive pin in the housing, the conductive pin spaced apart from a conductive pad on the surface of the second circuit board when no circuit board is inserted into the slot, the conductive pin to be urged into contact with the conductive pad when the first circuit board is inserted into the slot, the conductive pin to electrically couple the first circuit board to the conductive pad.

### BACKGROUND

In many electronic devices, one or more first circuit boards (e.g., memory board(s), dual in-line memory modules (DIMMs)) are electrically coupled to an underlying second circuit board (e.g., a motherboard, a printed circuit board (PCB)). Many such electronic devices include conductive pins to electrically couple the first circuit boards to the second circuit board and/or to other one(s) of the first circuit boards through conductive traces on the second circuit board.

### BRIEF DESCRIPTION OF THE DRAWINGS

FIG. 1 illustrates an example electronic device constructed in accordance with teachings of this disclosure.

FIG. 2A is a top view of the electronic device of FIG. 1, further including first and second example housings defining respective first and second slots to receive memory boards.

FIG. 2B is a cross-sectional view of the electronic device of FIGS. 1 and/or 2A.

FIG. 3A is a cross-sectional view of the second housing of FIGS. 2A and/or 2B during insertion of a second memory board in the second slot of the second housing.

FIG. 3B is a cross-sectional view of the second housing of FIGS. 2A and/or 2B after insertion of the second memory board of FIG. 3A in the second slot of the second housing.

FIG. 4 illustrates a second example electronic device constructed in accordance with teachings of this disclosure.

FIG. 5A is a top view of the second electronic device of FIG. 4, further including first and second example housings defining respective first and second slots to receive memory boards.

FIG. 5B is cross-sectional view of the second electronic device of FIGS. 4 and/or 5A.

FIG. 6A is a cross-sectional view of the second housing of FIGS. 5A and/or 5B during insertion of a second memory board in the second slot of the second housing.

FIG. 6B is a cross-sectional view of the second housing of FIGS. 5A and/or 5B after insertion of the second memory board of FIG. 6A in the second slot of the second housing.

FIG. 7 is a top view of the second pin array and the second support block of FIGS. 4, 5A, 5B, 6A, and/or 6B.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

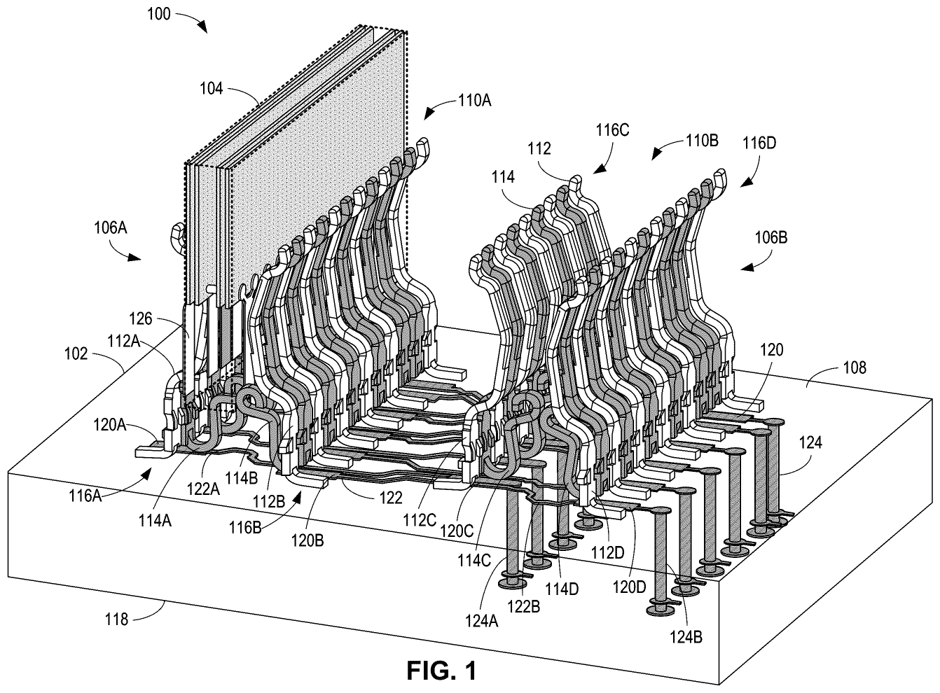

FIG. 1 illustrates an example electronic device (e.g., a computing device) 100 constructed in accordance with teachings of this disclosure. In the illustrated example of FIG. 1, the electronic device 100 includes an example circuit board (e.g., a printed circuit board (PCB), a motherboard) 102 to be electrically coupled to one or more example memory boards (e.g., first circuit boards, memory devices, memory module cards, dual in-line memory modules (DIMMs)) 104, one of which is shown in FIG. 1. In this example, the electronic device 100 includes a first example pin array (e.g., a first array of pins) 106A and a second example pin array (e.g., a second array of pins) 106B coupled and/or proximate to a first surface 108 of the circuit board 102. The first pin array 106A defines and/or corresponds to a first example memory slot (e.g., a first opening) 110A (or just slot for short) to receive a first memory board (e.g., the memory board 104 of FIG. 1), and the second pin array 106B defines and/or corresponds to a second memory slot (e.g., a second opening) 110B to receive a second memory board. In the illustrated example of FIG. 1, housings for the slots 110A, 110B to support the respective pin arrays 106A, 106B have been omitted for purposes of explanation and clarity.

In the illustrated example of FIG. 1, the first and second pin arrays 106A, 106B include example ground pins 112 (e.g., including at least a first ground pin 112A, a second ground pin 112B, a third ground pin 112C, and a fourth ground pin 112D) and example signal pins (e.g., conductive pins) 114 (e.g., including at least a first signal pin 114A, a second signal pin 114B, a third signal pin 114C, and a fourth signal pin 114D) to couple (e.g., electrically couple) the respective memory boards 104 to the circuit board 102. For purposes of distinction, the example signal pins 114 are represented in the drawings with a darker shading than the example ground pins 112. In this example, first ones of the ground pins 112 (e.g., the first ground pin 112A) and first ones of the signal pins 114 (e.g., the first signal pin 114A) are arranged in a first row 116A of the first pin array 106A, and second ones of the ground pins 112 (e.g., the second ground pin 112B) and second ones of the signal pins 114 (e.g., the second signal pin 114B) are arranged in a second row 116B of the first pin array 106A. Further, third ones of the ground pins 112 (e.g., the third ground pin 112C) and third ones of the signal pins 114 (e.g., the third signal pin 114C) are arranged in a third row 116C of the second pin array 106B, and fourth ones of the ground pins 112 (e.g., the fourth ground pin 112D) and fourth ones of the signal pins 114 (e.g., the fourth signal pin 114D) are arranged in a fourth row 116D of the second pin array 106B. In some examples, the ground pins 112 and the signal pins 114 in the respective rows 116 are arranged in an alternating manner (e.g., the ground pins 112 are positioned between respective pairs of the signal pins 114). In some examples, at least two of the signal pins 114 can be positioned adjacent to one another in one of the rows 116 (e.g., such that there is no ground pin 112 between the at least two signal pins 114). Likewise, in some examples, at least two of the ground pins 112 can be positioned adjacent to one another in one of the rows 116. In some examples, a number and/or arrangement of the ground pins 112 and/or the signal pins 114 can be different based on a type and/or size of the memory boards to be inserted in the respective slots 110A, 110B.

In the illustrated example of FIG. 1, the ground pins 112 are fixedly coupled to the first surface 108 of the circuit board 102. In some examples, the ground pins 112 are electrically coupled to one or more ground interconnects including contact pads, traces and/or vias (not shown) that are on, in, and/or extend along the circuit board 102 between the first surface 108 and a second surface 118 (e.g., opposite the first surface 108) of the circuit board 102. Further, the signal pins 114 are positioned proximate to respective example pads (e.g., conductive pads, contact pads, surface mount pads) 120 coupled to the first surface 108. In some examples, one(s) of the pads 120 are electrically coupled to other one(s) of the pads 120 through one or more example traces (e.g., conductive traces, conductive paths) 122 extending along the first surface 108. For example, first ones of the pads 120 associated with the first row 116A are electrically coupled to corresponding third ones of the pads 120 associated with the third row 116C (e.g., a first pad 120A is electrically coupled to a third pad 120C by a first trace 122A), and second ones of the pads 120 associated with the second row 116B are electrically coupled to corresponding fourth ones of the pads 120 associated with the fourth row 116D (e.g., a second pad 120B is electrically coupled to a fourth pad 120D by a second trace 122B). Further, the first ones of the pads 120 associated with the first row 116A are electrically isolated from the second ones of the pads 120 associated with the second row 116B (e.g., the first pad 120A is electrically isolated from the second pad 120B), and the third ones of the pads 120 associated with the third row 116C are electrically isolated from the fourth ones of the pads 120 associated with the fourth row 116D (e.g., the third pad 120C is electrically isolated from the fourth pad 120C). In some examples, ones of the conductive pads 120 are also electrically coupled (e.g., through respective ones of the traces 122) to one or more signal vias (e.g., conductive vias) 124 extending through the circuit board 102 between the first and second surfaces 108, 118.

In the illustrated example of FIG. 1, the first pin array 106A and the second pin array 106B are in a two slots per channel (2SPC) arrangement. In a 2SPC arrangement, each of the signal pins 114 in the first pin array 106A is electrically coupled, through a respective one of the traces 122, to a corresponding one of the signal pins 114 in the second pin array 106B and to a corresponding one of the signal vias 124 (e.g., the traces 122 define respective channels of the 2SPC arrangement) when memory boards are inserted into both of the first and second slots 110A, 110B. In other words, when memory boards are inserted into both of the slots 110A, 110B, each of the signal vias 124 is electrically coupled to a corresponding pair of the signal pins 114 in the first and second pin arrays 106A, 106B, where such an electrical connection is referred to herein as a channel. In this example, when memory boards are inserted into the slots 110A, 110B, the first contact pad 120A, the third contact pad 120C, the first trace 122A, and a first signal via 124A are electrically coupled (e.g., defining a first channel), and the second contact pad 120B, the fourth contact pad 120D, the second trace 122B, and a second signal via 124B are electrically coupled (e.g., defining a second channel). While FIG. 1 illustrates one instance of a 2SPC arrangement, the electronic device 100 may include multiple pairs of pin arrays 106A, 106B in a 2SPC arrangement in some examples.

In some examples, a processor (e.g., a CPU, a GPU, etc.) may be electrically coupled (e.g., through the traces 122 and/or the signal vias 124) to the memory boards inserted into the respective slots 110A, 110B. In such examples, when the processor communicates with (e.g., sends signal(s) to and/or obtains signal(s) from) one of the memory boards through a respective one of the traces 122, the signal(s) will necessarily also be received by the other memory board that is electrically coupled to the trace 122. In some examples, signals propagating along respective adjacent ones of the traces 122 (e.g., corresponding to adjacent channels) may interact with one another to produce adverse signaling effects (e.g., crosstalk), which may reduce reliability of the signals.

In the illustrated example of FIG. 1, the memory board 104 is inserted into the first slot 110A, and no memory board (e.g., no circuit board) is inserted into the second slot 110B. In the illustrated example of FIG. 1, portions of the memory board 104 have been made transparent for purposes of clarity and explanation, and example contact pads (e.g., electrical contacts) 126 of the memory board 104 are shown in contact with (and, thus, electrically coupled to) respective ones of the ground pins 112 and/or the signal pins 114 of the first pin array 106A. In this example, when either slot 110A, 110B is empty (e.g., no memory board is inserted therein) the signal pins 114 of the corresponding slot 110A, 110B are spaced apart from and/or are electrically isolated from the corresponding pads 120 on the circuit board 102. As a result, signals (e.g., electrical signals) propagating along the traces 122 do not flow to ones of the signal pins 114 corresponding to the empty slot 110A, 110B. Conversely, when a memory board (e.g., the memory board 104) is inserted into one of the slots 110A, 110B, the signal pins 114 of the corresponding slot 110A, 110B are urged into contact with the corresponding pads 120 (e.g., the signal pins 114 are electrically coupled to (e.g., are to electrically contact) the corresponding pads 120). In such examples, signals (e.g., electrical signals) can flow through the signal pins 114, the pads 120, and/or the traces 122 between the memory board inserted into the one of the slots 110A, 110B and the corresponding signal vias 124 (e.g., towards an electrically coupled processor and/or other circuitry).

In some examples, by electrically isolating the signal pins 114 from the corresponding pads 120 when no circuit board is inserted into a corresponding one of the slots 110A, 110B, examples disclosed herein can reduce crosstalk, impedance, resonance, stub effect, and/or other adverse signaling effects (e.g., compared to some known electronic devices having signal pins fixedly coupled to corresponding pads in a 2SPC arrangement). In some known electronic devices, for instance, signal pins of a memory slot are fixedly coupled to (e.g., in contact with) conductive pads on a surface of a circuit board. Stated differently, the signal pins in such known electronic devices are electrically coupled to the conductive pads regardless of whether a memory board is inserted into a slot associated with the signal pins. In such cases, when no memory board is inserted into the slot, electrical signals propagating through traces coupled to the conductive pads may flow and/or be diverted to the signal pins (e.g., the signal pins can absorb energy from the electrical signals). Such absorption of energy by the signal pins is referred to herein as stub effect. Stub effect may result in loss (e.g., insertion loss), resonance, and/or distortion of the electrical signals propagating through the traces.

As used herein, a “stub” refers to a signal pin that is coupled to (e.g., extends from) a conductive trace or pad on a first circuit board, but that is not coupled to a second circuit board (e.g., the stub extends from the conductive trace or pad and terminates at an open end of the stub). When a signal propagates through the conductive trace, a portion of the signal can travel through the stub. At particular frequencies (e.g., resonant frequences of the stub), the signal reflected off the open end of the stub can interfere with the signal propagating through the conductive trace, resulting in a dip in signal strength (e.g., insertion loss) at the particular frequencies. Additionally, the stubs can increase impedance of the signal propagating through the conductive trace, thus reducing reliability and/or speed of the signal.

In some known electronic devices, a dummy card (e.g., a dummy circuit board) may be inserted into an empty slot (e.g., a slot with no memory board inserted therein) to reduce some of the adverse signaling effects described above. For instance, the dummy card can include terminations (e.g., electrical terminations) to contact respective signal pins associated with the slot. Contact between the terminations and the respective signal pins can reduce the absorption of energy by the signal pins, thus reducing the stub effect and/or insertion losses associated with the signal pins. However, the use of dummy cards may increase weight and/or part costs associated with an electronic device. Examples disclosed herein can address the adverse signaling effects described above without the use of dummy cards.

For example, in the electronic device 100 of FIG. 1, the signal pins 114 are electrically isolated from (e.g., spaced apart from, not in contact with) the corresponding pads 120 when no circuit board (e.g., no memory board) is inserted into a corresponding one of the slots 110A, 110B. As a result, the signal pins 114 do not interfere with or absorb energy from electrical signals propagating through the traces 122 (e.g., the signal pins 114 do not produce a stub effect) when no circuit board is inserted into the corresponding one of the slots 110A, 110B. Accordingly, the signal pins 114 of FIG. 1 can reduce insertion loss, impedance, and/or other adverse signaling effects for signals propagating through the electronic device 100 (e.g., compared to some known electronic devices in which the signal pins are fixed to an underlying circuit board).

In the illustrated example of FIG. 1, when a memory board is inserted into a corresponding one of the slots 110A, 110B of FIG. 1, the signal pins 114 associated with the one of the slots 110A, 110B can be urged into contact with the corresponding pads 120 (e.g., through flexion and/or movement of the signal pins 114). For example, as a result of the memory board 104 of FIG. 1 being inserted in the first slot 110A, first ones of the signal pins 114 in the first pin array 106A are in contact (e.g., electrical contact) with and/or electrically coupled to corresponding first ones of the pads 120, and further electrically coupled to the signal vias 124 through the traces 122. Further, because no memory board is inserted into the second slot 110B, second ones of the signal pins 114 in the second pin array 106B are spaced apart from and/or electrically isolated from the corresponding pads 120 and, thus, from the traces 122. As a result, when signals flow between the memory board 104 and the signal vias 124 (e.g., through the corresponding signal pins 114 of the first pin array 106A, the pads 120, and the traces 122), the signal pins 114 of the second pin array 106B do not interfere with or absorb energy from the signals.

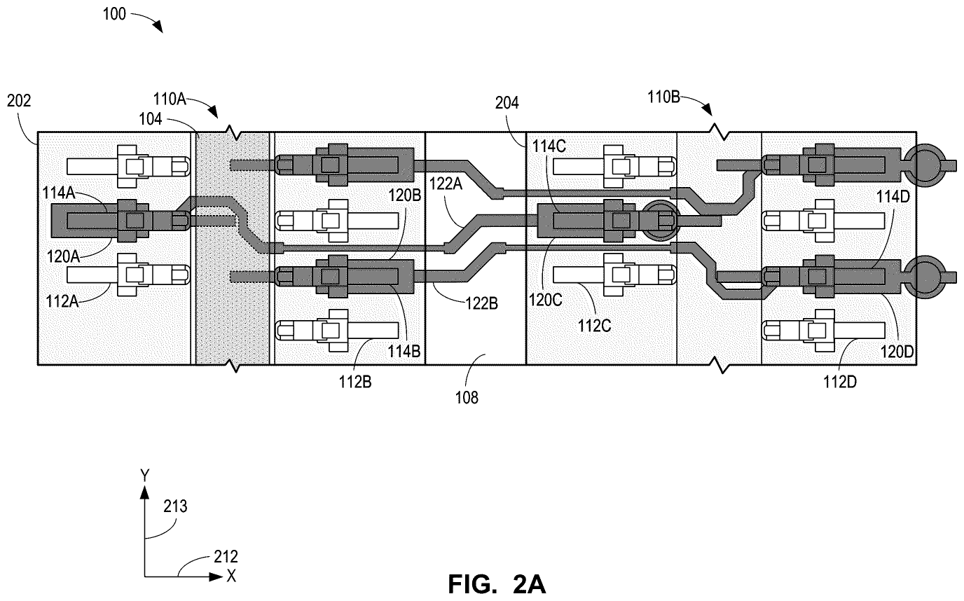

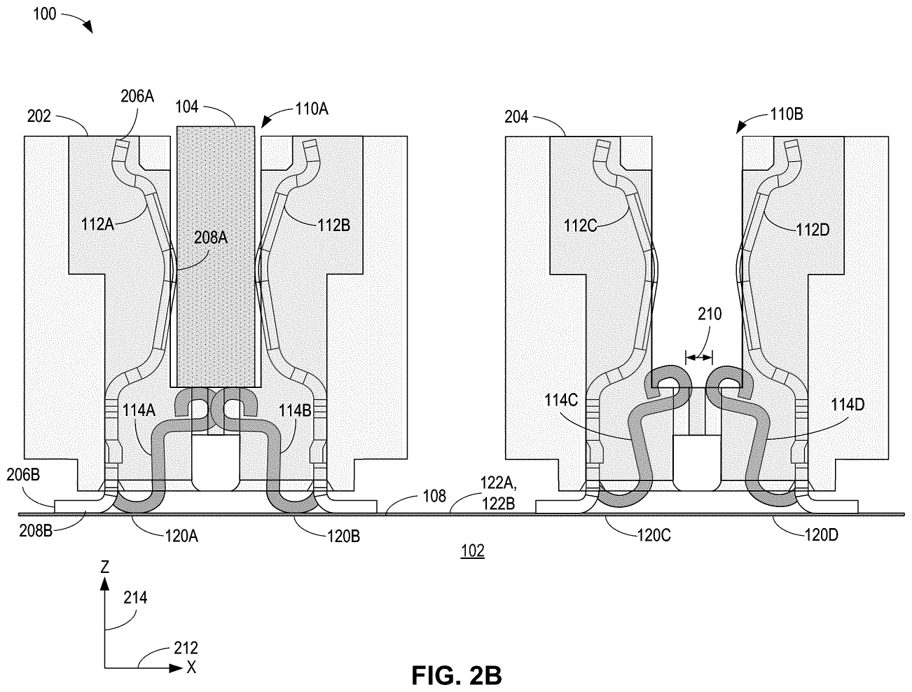

FIGS. 2A and 2B are a top view and a cross-sectional view, respectively, of a portion of the electronic device 100 of FIG. 1. In the illustrated examples of FIGS. 2A and 2B, the electronic device 100 includes first and second example housings (e.g., housing inserts) 202, 204 defining the first and second slots 110A, 110B, respectively, into which memory boards (e.g., the memory board 104) may be received. The housings 202, 204 are spaced apart from and positioned proximate to the first surface 108 of the circuit board 102 of FIG. 1 (e.g., the housings 202, 204 are supported on the circuit board 102). In this example, the first and second ground pins 112A, 112B and the first and second signal pins 114A, 114B of the first pin array 106A of FIG. 1 are positioned in (e.g., extend through at least a portion of) the first housing 202, and the third and fourth ground pins 112C, 112D and the third and fourth signal pins 114C, 114D of the second pin array 106B of FIG. 1 are positioned in (e.g., extend through at least a portion of) the second housing 204. In the illustrated example of FIG. 2B, the first and second traces 122A, 122B and the first, second, third, and fourth pads 120A, 120B, 120C, 120D are represented by a same strip of material on the surface 108 of the circuit board 102 (e.g., the solid shaded line extending the full width along the bottom of the figure). However, as shown in FIG. 2A, the first trace 122A, the second trace 122B, and the pads 120A, 120B, 120C, 120D correspond to respective different locations on the first surface 108 (e.g., along a top plane defined by a first example axis (e.g., an X-axis) 212 and a second example axis (e.g., a Y-axis) 213 in FIG. 2A).

As shown in FIG. 2B, the first ground pin 112A extends between a first end 206A and a second end 206B, where the first end 206A is within the first housing 202 and the second end 206B extends from (e.g., is outside of) the first housing 202. A first portion 208A of the first ground pin 112A between the first and second ends 206A, 206B extends into the first slot 110A to contact the memory board 104 when the memory board 104 is inserted into the first slot 110A. A second portion 208B of the first ground pin 112A proximate the second end 206B is fixedly coupled to the first surface 108 of the circuit board 102 to couple (e.g., fixedly couple) the first housing 202 to the circuit board 102. In some examples, the first ground pin 112A electrically couples the memory board 104 to one or more ground vias (not shown) in the circuit board 102. The second ground pin 112B is substantially the same as the first ground pin 112A, such that the description of the first ground pin 112A applies equally to the second ground pin 112B. Further, the third and fourth ground pins 112C, 112D are substantially the same as the first and second ground pins 112A, 112B, but with respect to the second housing 204 and the second slot 110B.

In the illustrated examples of FIGS. 2A and 2B, the signal pins 114A, 114B, 114C, 114D are positioned in and movable (e.g., translatable and/or flexible) with respect to the respective housings 202, 204. For example, the signal pins 114A, 114B, 114C, 114D can move and/or flex from a first position (e.g., an unflexed position, a decoupled position) in which the signal pins 114A, 114B, 114C, 114D are spaced apart from (e.g., do not contact, are electrically isolated from) the respective pads 120A, 120B, 120C, 120D, and a second position (e.g., a flexed position, a coupled position) in which the signal pins 114A, 114B, 114C, 114D contact (e.g., are electrically coupled to) the respective pads 120A, 120B, 120C, 120D. In the illustrated examples of FIGS. 2A and 2B, as a result of the second slot 110B being empty (e.g., no circuit board is inserted into the second slot 110B), the third and fourth signal pins 114C, 114D are in the first position (e.g., are spaced apart from respective third and fourth pads 120C, 120D). In this example, the third and fourth signal pins 114C, 114D are spaced apart by a first example distance 210 along an example front plane defined by a first example axis (e.g., an X-axis) 212 and a third example axis (e.g., a Z-axis) 214 in FIG. 2B.

In the illustrated examples of FIGS. 2A and 2B, as a result of the memory board 104 being inserted into the first slot 110A, the first and second signal pins 114A, 114B are in the second position (e.g., are electrically coupled to and/or are urged into contact with the respective first and second pads 120A, 120B). For example, the first and second signal pins 114A, 114B move to the second position as a result of contact between the first and second signal pins 114A, 114B and the memory board 104. In this example, when the first and second signal pins 114A, 114B are in the second position shown in FIG. 2B, the first and second signal pins 114A, 114B are overlapping in the front plane (e.g., the first and second signal pins 114A, 114B are spaced apart by a second distance (e.g., 0) less than the first distance 210). Although overlapping in the front plane shown in FIG. 2B, the first and second signal pins 114A, 114B remain electrically isolated because they are offset or staggered in the Y-direction (e.g., into and out of the page). Stated differently, the first and second signal pins 114A, 114B move closer together when the first and second signal pins 114A, 114B move from the first position to the second position.

In some electronic devices, crosstalk (e.g., far-end crosstalk (FEXT), inductance crosstalk) may occur between signals (e.g., electrical signals) propagating along different traces to pads on a same side of a memory board and/or on opposite sides of the memory board. Such crosstalk may distort and/or reduce reliability of the signals. In the illustrated example of FIG. 2B, by reducing a distance between respective pairs of the signal pins 114 (e.g., the first and second signal pins 114A, 114B, the third and fourth signal pins 114C, 114D) when the signal pins 114 are in the second position (e.g., electrically coupled to the corresponding pads 120), a capacitance between the pair of signal pins 114 can be increased. For example, as a result of the first and second signal pins 114A, 114B overlapping in FIG. 2B (though still offset and, thus, electrically isolated), the first and second signal pins 114A, 114B can form a capacitor when signals propagate through the first and second signal pins 114A, 114B. In some examples, increasing the capacitance between the pair of signal pins 114 can reduce crosstalk (e.g., inductance crosstalk) between the signals travelling along the signal pins 114 and the corresponding traces 122 of FIG. 1.

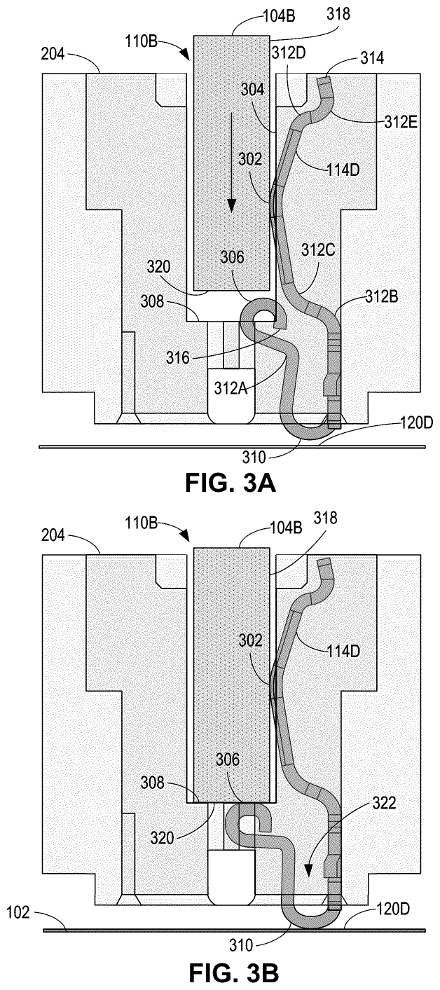

FIGS. 3A and 3B are cross-sectional views of the second housing 204 of FIGS. 2A and/or 2B during insertion and after insertion, respectively, of a second memory board (e.g., a second circuit board) 104B in the second slot 110B of the second housing 204, with the third signal pin 114C, the third ground pin 112C, and the fourth ground pin 112D of FIGS. 1, 2A, and/or 2B (and all other pins of the second slot 110B) removed for purposes of explanation and clarity. In the illustrated example of FIG. 3A, the second memory board 104B is partially inserted into the second slot 110B, such that the second memory board 104B contacts a first portion (e.g., a first curved portion) 302 of the fourth signal pin 114D extending into the second slot 110B (e.g., extending from a sidewall surface 304 of the second housing 204), but does not contact (e.g., has not yet reached) a second portion (e.g., a second curved portion) 306 of the fourth signal pin 114D extending into the second slot 110B (e.g., extending from a seating surface 308 of the second housing 204).

In this example, the fourth signal pin 114D includes a substantially U-shaped portion (e.g., a third curved portion, a U-shaped bend) 310 between the first portion 302 and the second portion 306, where the U-shaped portion 310 extends from the second housing 204 proximate the fourth pad 120D. In some examples, when the second memory board 104B is partially inserted into the second slot 110B, the U-shaped portion 310 is in the first position (e.g., is spaced apart and/or electrically isolated from the fourth pad 120D). In the illustrated example of FIG. 3A, the fourth signal pin 114D includes additional example bends (e.g., curved portions) 312A, 312B, 312C, 312D, 312E between the first portion 302 and the second portion 306 and/or between the first portion 302 and a first end 314 of the fourth signal pin 114D. As shown in FIG. 2B, the second portion 306 is proximate a second end 316 (e.g., opposite the first end 314) of the fourth signal pin 114D. In this example, the second portion 306 curves (e.g., curls) from the seating surface 308 toward the sidewall surface 304, and the second end 316 of the fourth signal pin 114D is positioned in (e.g., extends into) the second housing 204. In some examples, the fourth signal pin 114D can have a different shape from what is shown in FIG. 3A. For instance, in some examples, the second portion 306 curves (e.g., curls) in the opposite direction with the second end 316 positioned below the seating surface 308. Further, in some examples, the size of the curved portions 302, 306, 310 (e.g., the radius of curvature and/or the total angle of rotation followed by each curved portion) can be larger or smaller than what is shown in FIG. 3A. Further still, in some examples, one or more of the additional example bends 312A, 312B, 312C, 312D, 312E may be omitted and/or bent to a different degree (e.g., a different angle) and/or in a different direction from what is shown in FIG. 3A. Additionally, in some examples, the fourth signal pin 114D includes other bends and/or curved portions not shown in the illustrated example.

Turning to FIG. 3B, the second memory board 104B is shown inserted (e.g., fully inserted) into the second slot 110B. In the illustrated example of FIG. 3B, when the second memory board 104B is inserted into the second slot 110B, the first portion 302 of the fourth signal pin 114D contacts a first surface 318 of the second memory board 104B, and the second portion 306 of the fourth signal pin 114D contacts a second surface 320 of the second memory board 104B, where the second surface 320 is different from (e.g., substantially perpendicular to) the first surface 318. More particularly, as shown in the illustrated example, the first surface 318 corresponds to a side of the second memory board 104B whereas the second surface 320 corresponding to a bottom edge of the second memory board 104B. Further, the second surface 320 of the second memory board 104B contacts the seating surface 308 of the second housing 204, such that the seating surface 308 prevents further downward motion (e.g., toward the circuit board 102) of the second memory board 104B.

In the illustrated example of FIG. 3B, the second memory board 104B urges the fourth signal pin 114D into contact with the fourth pad 120D. For example, the second surface 320 of the second memory board 104B urges the second portion 306 of the fourth signal pin 114D toward the circuit board 102 such that the second portion 306 is disposed in the second housing 204 (e.g., does not extend into the second slot 110B). Further, the U-shaped portion 310 contacts the fourth pad 120D, such that the fourth signal pin 114D is electrically coupled to the fourth pad 120D (e.g., the fourth signal pin 114D is in the second position). As a result, the fourth signal pin 114D is electrically coupled to the second signal pin 114B of FIGS. 2A and/or 2B through the fourth pad 120D, one(s) of the traces 122 (e.g. the second trace 122B shown in FIG. 2A), and the second pad 120B of FIGS. 2A and/or 2B. In some examples, the fourth signal pin 114D flexes as a result of contact with the second memory board 104B. For example, an opening 322 of the U-shaped portion 310 can increase (e.g., widen) when the fourth signal pin 114D moves from the first position of FIG. 3A to the second position of FIG. 3B. In some examples, when the second memory board 104B is removed from the second slot 110B, spring forces within the fourth signal pin 114D reverse this process and return the fourth signal pin 114D to the first position as shown in FIG. 3A.

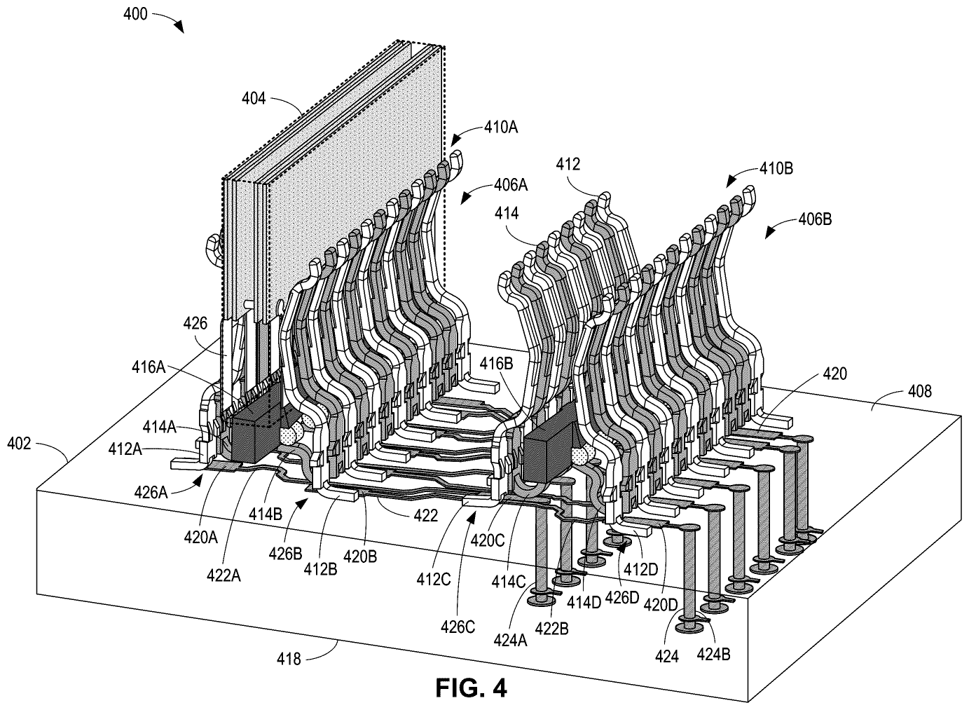

FIG. 4 illustrates a second example electronic device (e.g., a second compute system) 400 constructed in accordance with teachings of this disclosure. In the illustrated example of FIG. 4, similar to the electronic device 100 of FIG. 1, the second electronic device 400 includes an example circuit board (e.g., a printed circuit board (PCB), a motherboard) 402 to be electrically coupled to one or more example memory boards (e.g., first circuit boards, memory devices, memory module cards, dual in-line memory modules (DIMMs)) 404, one of which is shown in FIG. 4. In this example, the second electronic device 400 includes a first example pin array 406A and a second example pin array 406B coupled and/or proximate to a first surface 408 of the circuit board 402. The first pin array 406A defines and/or corresponds to a first example memory slot 410A (or just slot for short) to receive a first memory board (e.g., the memory board 404 of FIG. 4), and the second pin array 406B defines and/or corresponds to a second memory slot 410B to receive a second memory board.

In the illustrated example of FIG. 4, the first and second pin arrays 406A, 406B include example ground pins 412 (e.g., including at least a first ground pin 412A, a second ground pin 412B, a third ground pin 412C, and a fourth ground pin 412D) and example signal pins (e.g., conductive pins) 414 (e.g., including at least a first signal pin 414A, a second signal pin 414B, a third signal pin 414C, and a fourth signal pin 414D) to couple (e.g., electrically couple) the respective memory board(s) 404 to the circuit board 402. For purposes of distinction, the example signal pins 414 are represented in the drawings with a darker shading than the example ground pins 412. In the illustrated example of FIG. 4, the pin arrays 406A, 406B are in a 2SPC arrangement (similar to the pin arrays 106A, 106B of FIG. 1). In this example, the ground pins 412 of FIG. 4 are substantially the same as the ground pins 112 of the electronic device 100 of FIG. 1. However, in this example, the signal pins 414 of FIG. 4 have a different shape compared to the signal pins 114 of the electronic device 100 of FIG. 1. In the illustrated example of FIG. 4, the second electronic device 400 includes a first example support block 416A and a second example support block 416B within the respective first pin array 406A and the second pin array 406B. In some examples, the support blocks 416A, 416B are movable with respect to (e.g., toward and/or away from) the first surface 408 of the circuit board 402. In some examples, the signal pins 414 are to contact respective ones of the support blocks 416A, 416B (e.g., when a memory board is inserted into respective one(s) of the slots 110A, 110B), such that movement of the support blocks 416A, 416B results in movement (e.g., flexion and/or translation) of the corresponding signal pins 414. In some examples, the support blocks 416A, 416B may rest on (e.g., be in contact with) the signal pins 414 even when no memory board is inserted into respective one(s) of the slots 110A, 110B. However, in some such examples, the weight of the support blocks 416A, 416B is insufficient to cause movement of the signal pins 414 in the same way that a memory board does as detailed further below.

In the illustrated example of FIG. 4, the ground pins 412 are fixedly coupled to the first surface 408 of the circuit board 402. In some examples, the ground pins 412 are electrically coupled to one or more ground vias (not shown) that extend through the circuit board 402 between the first surface 408 and a second surface 418 (e.g., opposite the first surface 408) of the circuit board 402. Further, the signal pins 414 are positioned proximate to respective example pads (e.g., conductive pads, contact pads, surface mount pads) 420 (including at least a first pad 420A, a second pad 420B, a third pad 420C, and a fourth pad 420D) coupled to the first surface 408. In some examples, one(s) of the pads 420 are electrically coupled to other one(s) of the pads 420 through one or more example traces (e.g., conductive traces) 422 extending along the first surface 408. For example, first ones of the pads 420 associated with a first row 426A of the first pin array 406A are electrically coupled to corresponding third ones of the pads 420 associated with a third row 426C of the second pin array 406B (e.g., the first pad 420A is electrically coupled to the third pad 420C via a first trace 422A), and second ones of the pads 420 associated with a second row 426B of the first pin array 406A are electrically coupled to corresponding fourth ones of the pads 120 associated with a fourth row 426D of the second pin array 406B (e.g., the second pad 420B is electrically coupled to the fourth pad 420D via a second trace 422B). Further, the first ones of the pads 420 associated with the first row 426A are electrically isolated from the second ones of the pads 420 associated with the second row 426B (e.g., the first pad 420A is electrically isolated from the second pad 420B), and the third ones of the pads 420 associated with the third row 426C are electrically isolated from the fourth ones of the pads 420 associated with the fourth row 426D (e.g., the third pad 420C is electrically isolated from the fourth pad 420D). In some examples, ones of the conductive pads 420 are also electrically coupled (e.g., through respective ones of the traces 422) to one or more signal vias (e.g., conductive vias) 424 extending through the circuit board 402 between the first and second surfaces 408, 418. For example, a first signal via 424A is electrically coupled to the first pad 420A and the third pad 420C through the first trace 422A (defining a first channel), and a second signal via 424B is electrically coupled to the second pad 420B and the fourth pad 420D through the second trace 422B (defining a second channel).

In the illustrated example of FIG. 4, the memory board 404 is inserted into the first slot 410A, and no memory board (e.g., no circuit board) is inserted into the second slot 410B. In the illustrated example of FIG. 4, portions of the memory board 404 have been made transparent for purposes of clarity and explanation, and example contact pads (e.g., electrical contacts) 426 of the memory board 104 are shown in contact with (and, thus, electrically coupled to) respective ones of the ground pins 412 and/or the signal pins 414 of the first pin array 406A. In some examples, when either slot 410A, 410B is empty (e.g., no memory board is inserted therein), the signal pins 414 of the corresponding slot 410A, 410B are spaced apart from and/or are electrically isolated from the corresponding pads 420 on the circuit board 402. As a result, signals (e.g., electrical signals) propagating along the traces 422 do not flow to ones of the signal pins 414 of the corresponding empty slot 410A, 410B. Conversely, when a memory board (e.g., the memory board 404) is inserted into one of the slots 410A, 410B, one of the support blocks 416A, 416B of the corresponding slot 410A, 410B urges the corresponding signal pins 414 into contact with the corresponding pads 420 (e.g., such that the signal pins 414 are electrically coupled to the corresponding pads 420). In such examples, signals (e.g., electrical signals) can flow through the signal pins 414, the pads 420, and/or the traces 422 between the memory board inserted into the one of the slots 410A, 410B and the corresponding signal vias 424 (e.g., towards an electrically coupled processor and/or other circuitry). Similar to the example of FIG. 1, by electrically isolating the signal pins 414 of FIG. 4 from the corresponding pads 420 when no circuit board is inserted into a corresponding one of the slots 410A, 410B, examples disclosed herein can reduce crosstalk, impedance, resonance, stub effect, and/or other adverse signaling effects (e.g., compared to some known electronic devices having signal pins fixedly coupled to corresponding pads in a 2SPC arrangement).

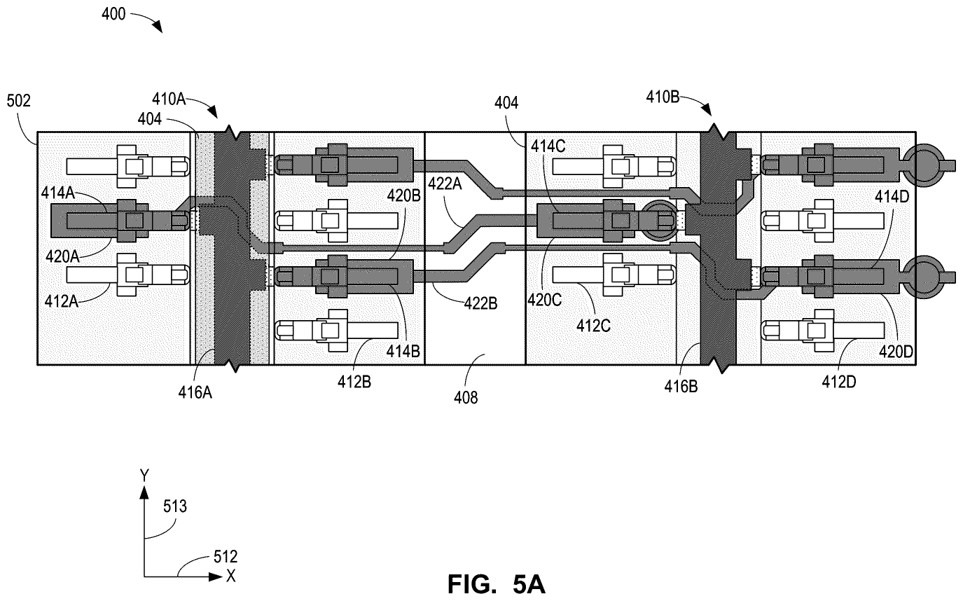

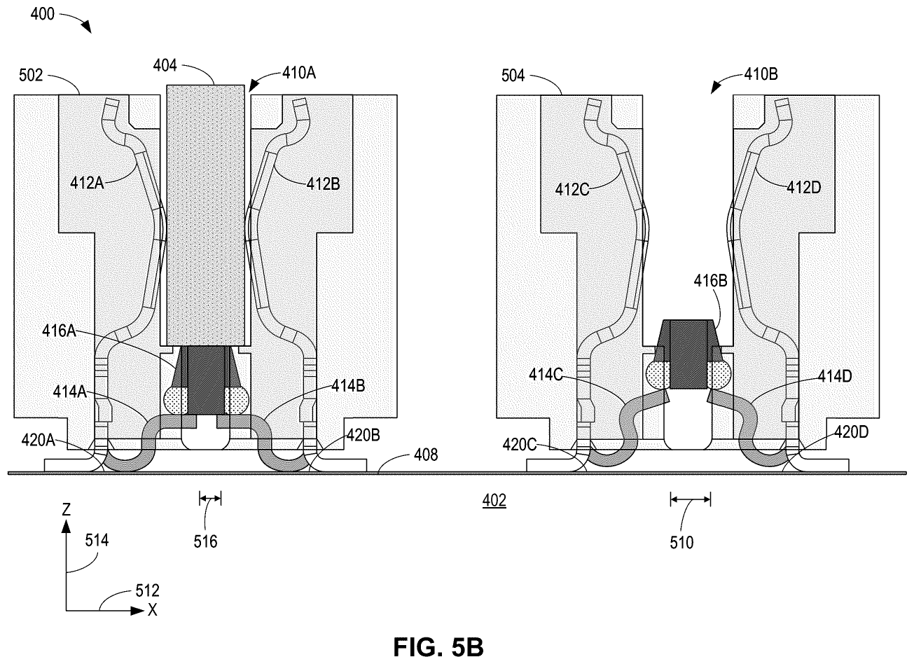

FIGS. 5A and 5B are a top view and a cross-sectional view, respectively, of the second electronic device 400 of FIG. 4, further including first and second example housings (e.g., housing inserts) 502, 504 defining the first and second slots 410A, 410B, respectively. In the illustrated examples of FIGS. 5A and 5B, the housings 502, 504 are spaced apart from and positioned proximate to the first surface 408 of the circuit board 402 (e.g., the housings 502, 504 are supported on the circuit board 402). In this example, first and second ground pins 412A, 412B and first and second signal pins 414A, 414B of the first pin array 406A of FIG. 4 are positioned in (e.g., extend through at least a portion of) the first housing 502, and third and fourth ground pins 412C, 412D and third and fourth signal pins 414C, 414D of the second pin array 406B of FIG. 4 are positioned in (e.g., extend through at least a portion of) the second housing 504. Further, the first support block 416A is within the first housing 502, and the second support block 416B is within the second housing 504.

In the illustrated example of FIGS. 5A and 5B, the signal pins 414A, 414B, 414C, 414D and the support block 416A, 416B are movable (e.g., translatable and/or flexible) with respect to the respective housings 502, 504. For example, the signal pins 414A, 414B, 414C, 414D and the support blocks 416A, 416B can move from a first position in which the signal pins 414A, 414B, 414C, 414D are spaced apart from (e.g., do not contact, are electrically isolated from) the respective first, second, third, and fourth pads 420A, 420B, 420C, 420D, and a second position in which the signal pins 414A, 414B, 414C, 414D are urged into contact with (e.g., are electrically coupled to) the respective pads 420A, 420B, 420C, 420D. In the illustrated example of FIG. 5B, the first and second traces 422A, 422B and the first, second, third, and fourth pads 420A, 420B, 420C, 420D are represented by a same strip of material on the surface 408 of the circuit board 402 (e.g., the solid shaded line extending the full width along the bottom of the figure). However, as shown in FIG. 4A, the first trace 422A, the second trace 422B, and the pads 420A, 420B, 420C, 420D correspond to respective different locations on the first surface 408 (e.g., along a top plane defined by a first example axis (e.g., an X-axis) 512 and a second example axis (e.g., a Y-axis) 513 in FIG. 5A).

In the illustrated examples of FIGS. 5A and 5B, as a result of the second slot 410B being empty (e.g., no circuit board is inserted into the second slot 410B), the second support block 416B and the third and fourth signal pins 414C, 414D are in the first position (e.g., such that the third and fourth signal pins 414C, 414D are spaced apart from the respective third and fourth pads 420C, 420D). In this example, the third and fourth signal pins 414C, 414D are spaced apart by a first example distance 510 along an example front plane in FIG. 5B defined by a first example axis (e.g., an X-axis) 512 and a second example axis (e.g., a Z-axis) 514 in FIG. 5B. Further, when the second support block 416B is in the first position, the second support block 416B extends into the second slot 410B. In this example, the second support block 416B contacts the third and fourth signal pins 414C, 414D when the second support block 416B is in the first position of FIG. 4. In some examples, the second support block 416B is spaced apart from (e.g., does not contact) the third and fourth signal pins 414C, 414D when the second support block 416B is in the first position. In such examples, when the second support block 416B moves from the first position to the second position (e.g., in which the third and fourth signal pins 414C, 414D contact the respective third and fourth pads 420C, 420D), the second support block 416B moves (e.g., travels) a distance within the second housing 504 before contacting the third and fourth signal pins 414C, 414D and/or before movement of the third and fourth signal pins 414C, 414D to the second position.

In the illustrated examples of FIGS. 5A and 5B, as a result of the memory board 404 being inserted into the first slot 410A, the first and second signal pins 414A, 414B and the first support block 416A are in the second position (e.g., such that the first and second signal pins 414A, 414B are electrically coupled to and/or are urged into contact with the respective first and second pads 420A, 420B). For example, when the memory board 404 is inserted into the first slot 410A, contact between the memory board 404 and the first support block 416A results in movement (e.g., translation) of the first support block 416A toward the first surface 408 of the circuit board 402. Further, the movement of the first support block 416A results in movement (e.g., translation and/or flexion) of the first and second signal pins 414A, 414B, such that the first and second signal pins 414A, 414B are urged into contact with the respective first and second pads 420A, 420B when the first and second signal pins 414A, 414B are in the second position. In this example, when the first and second signal pins 414A, 414B are in the second position, the first and second signal pins 114A, 114B are spaced apart by a second distance 516 along the front plane of FIG. 5B, where the second distance 516 is less than the first distance 510 in the first position. Stated differently, the first and second signal pins 414A, 414B move closer together when the first and second signal pins 414A, 414B move from the first position to the second position. As a result, a capacitance between the first and second signal pins 414A, 414B increases as the first and second signal pins 414A, 414B move from the first position to the second position which, in turn, can reduce crosstalk (e.g., inductance crosstalk) between signals travelling along the first and second signal pins 414A, 414B.

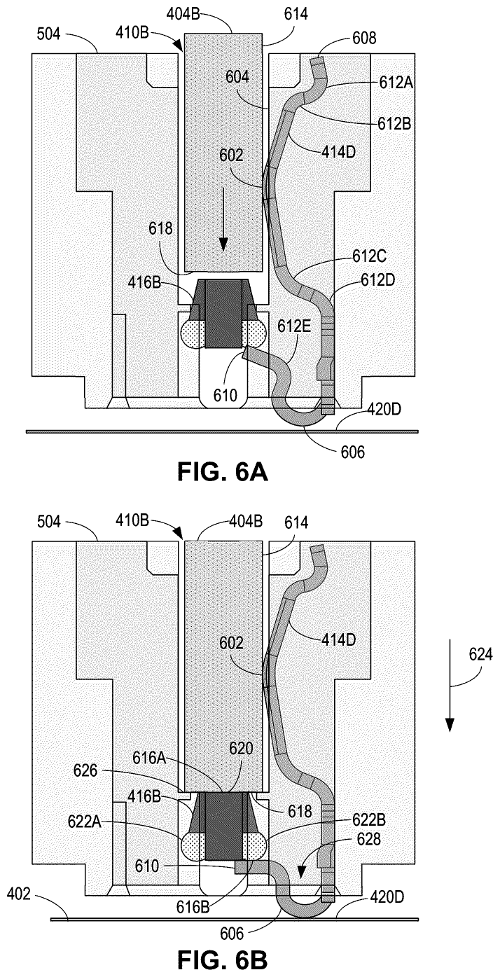

FIGS. 6A and 6B are cross-sectional views of the second housing 504 of FIGS. 5A and/or 5B during and after insertion of a second memory board (e.g., a third circuit board) 404B in the second slot 410B of the second housing 504, with the third signal pin 414C, the third ground pin 412C, and the fourth ground pin 412D of FIGS. 4, 5A, and/or 5B (and all other pins of the second slot 410B) removed for purposes of explanation and clarity. Turning to FIG. 6A, the second memory board 404B is partially inserted into the second slot 410B, such that the second memory board 404B contacts a first portion (e.g., a first curved portion) 602 of the fourth signal pin 414D extending into the second slot 410B (e.g., from a sidewall surface 604 of the second housing 504), but does not contact (e.g., has not yet reached) the second support block 416B (e.g., such that the second support block 416B and the fourth signal pin 414D remain in the first position of FIGS. 5A and/or 5B).

In the illustrated example of FIG. 6A, the fourth signal pin 414D includes a substantially U-shaped portion 606 between a first end 608 and a second end 610 of the fourth signal pin 414D. In this example, the U-shaped portion 606 extends from the second housing 504 proximate the fourth pad 420D. In this example, when the second memory board 404B is partially inserted into the second slot 410B, the U-shaped portion 606 is spaced apart and/or electrically isolated from the fourth pad 420D. In the illustrated example of FIG. 6A, the fourth signal pin 614D includes additional example bends (e.g., curved portions) 612A, 612B, 612C, 612D, 612E between the first end 608 and the second end 610. In some examples, the fourth signal pin 414D can have a different shape from what is shown in FIG. 6A. Further, in some examples, the size of (e.g., the radius of curvature and/or the total angle of rotation followed by each of) the U-shaped portion 606 and/or the bend(s) 612A, 612B, 612C, 612D, 612E can be larger or smaller than what is shown in FIG. 6A. Further still, in some examples, one or more of the additional example bends 612A, 612B, 612C, 612D, 612E may be omitted and/or bent to a different degree (e.g., a different angle) and/or in a different direction from what is shown in FIG. 6A. Additionally, in some examples, the fourth signal pin 414D includes other bends and/or curved portions not shown in the illustrated example. In some examples, the fourth signal pin 414D shown in FIGS. 6A and 6B is shaped similarly to the fourth signal pin 114D shown in FIGS. 3A and 3B. Likewise, in some examples, the fourth signal pin 114D shown in FIGS. 3A and 3B is shaped similarly to the fourth signal pin 414D shown in FIGS. 6A and 6B.

Turning to FIG. 6B, the second memory board 404B is shown inserted (e.g., fully inserted) into the second slot 410B. In the illustrated example of FIG. 6B, when the second memory board 404B is inserted into the second slot 410B, the first portion 602 of the fourth signal pin 414D contacts a first surface 614 of the second memory board 404B, and a first contact surface 616A of the second support block 416B contacts a second surface 618 of the second memory board 404B, where the second surface 618 is different from (e.g., is substantially perpendicular to) the first surface 614. More particularly, as shown in the illustrated example, the first surface 614 corresponds to a side of the second memory board 404B whereas the second surface 618 corresponding to a bottom edge of the second memory board 404B. Further, a second contact surface 616B of the second support block 416B contacts a portion of the fourth signal pin 414D proximate the second end 610 of the fourth signal pin 414D.

In the illustrated example of FIG. 6B, the second support block 416B includes a base portion (e.g., a non-conductive portion) 620, and first and second example pin contact portions (e.g., first and second conductive portions) 622A, 622B coupled to and/or extending from the base portion 620. In this example, the first contact surface 616A corresponds to the base portion 620, and the second contact surface 616B corresponds to the second pin contact portion 622B. In some examples, the base portion 620 is a non-conductive material, and the pin contact portions 622A, 622B are a conductive material (e.g., metal). In some examples, the conductive material of the pin contact portions 622A, 622B is the same as (or substantially similar to) a conductive material of the signal pins 414. For example, the conductive material of the pin contact portions 622A, 622B can have a same or similar hardness, density, conductivity, etc. as the conductive material of the signal pins 414. In some examples, the pin contact portions 622A, 622B are not conductive (e.g., the pin contact portions 622A, 622B can be the same non-conductive material as the base portion 620 and/or a different non-conductive material).

In the illustrated example of FIG. 6B, the pin contact portions 622A, 622B are rounded (e.g., have a circular cross-sectional shape). In some examples, as a result of the rounded shape of the pin contact portions 622A, 622B, the pin contact portions 622A, 622B can reduce wear of and/or damage to the respective signal pins 414 during contact between the pin contact portions 622A, 622B and the respective signal pins 414 (e.g., compared to when the pin contact portions 622A, 622B are not rounded and/or have sharp edges). In some examples, the pin contact portions 622A, 622B can have a different shape from what is shown in FIGS. 6A and/or 6B (e.g., the pin contact portions 622A, 622B are not rounded in some examples).

In some examples, to move the second support block 416B and the fourth signal pin 414D from the first position of FIG. 6A to the second position of FIG. 6B, the second memory board 404B urges the second support block 416B toward the circuit board 402. For example, the second memory board 404B moves in a downward direction (e.g., a negative Z-direction) 624 until the second surface 618 of the second memory board 404B contacts (e.g., engages) a seating surface 626 of the second housing 504 (e.g., such that the seating surface 626 prevents further downward movement of the second memory board 404B). Further, the second support block 416B moves with the second memory board 404B (e.g., in the downward direction 624), such that the first contact surface 616A of the second support block 416B is substantially aligned with the seating surface 626 of the second housing 504 in the second position of FIG. 6B. In the illustrated example of FIG. 6B, the movement of the second support block 416B in the downward direction 624 urges the fourth signal pin 414D into contact with the fourth pad 420D. For example, the U-shaped portion 606 of the fourth signal pin 414D contacts the fourth pad 420D to electrically couple the fourth signal pin 414D to the fourth pad 420D. As a result, the fourth signal pin 414B is electrically coupled to the second signal pin 414B of FIG. 4 through the fourth pad 420D, one(s) of the traces 422 (e.g., the second trace 422B) of FIG. 4, and the second pad 420B of FIGS. 5A and/or 5B. In some examples, the fourth signal pin 414D flexes as a result of the movement of the second support block 416B. For example, an opening 628 of the U-shaped portion 606 can increase (e.g., widen) when the fourth signal pin 414D moves from the first position of FIG. 6A to the second position of FIG. 6B. In some examples, when the second memory board 404B is removed from the second slot 410B, spring forces within the fourth signal pin 414D reverse this process and return the fourth signal pin 414D to the first position as shown in FIG. 6A.

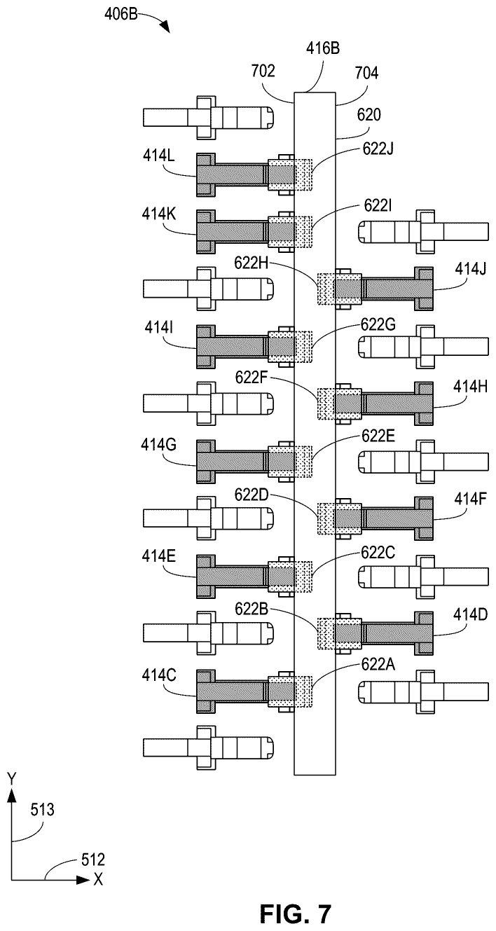

FIG. 7 is a top view of the second pin array 406B and the second support block 416B of FIGS. 4, 5A, 5B, 6A, and/or 6B, with the base portion 620 and the pin contact portions 622 made transparent for purposes of explanation and clarity. In the illustrated example of FIG. 7, the second support block 416B includes first ones of the pin contact portions 622 (e.g., including the first pin contact portion 622A, a third pin contact portion 622C, a fifth pin contact portion 622E, and a seventh pin contact portion 622G, a ninth pin contact portion 622I, and a tenth pin contact portion 622J) on a first side 702 of the second support block 416B, and includes second ones of the pin contact portions 622 (e.g., including the second pin contact portion 622B, a fourth pin contact portion 622D, a sixth pin contact portion 622F, and an eighth pin contact portion 622H) on a second side 704 of the second support block 416B (e.g., opposite the first side 702). In this example, the second support block 416B includes six of the pin contact portions 622 on the first side 702 and four of the pin contact portions 622 on the second side 704. In some examples, the second support block 416B can include a different number of the pin contact portions 622 on the first side 702 and/or the second side 704 (e.g., based on the number of the signal pins 414 to be coupled to the respective first and second sides 702, 704).

In the illustrated example of FIG. 7, the pin contact portions 622 contact respective ones of the signal pins 414 (e.g., including the third signal pin 414C, the fourth signal pin 414D, a fifth signal pin 414E, a sixth signal pin 414F, a seventh signal pin 414G, an eighth signal pin 414H, a ninth signal pin 414I, a tenth signal pin 414J, an eleventh signal pin 414K, and a twelfth signal pin 414L) to urge the signal pins 414 into contact with respective ones of the pads 420 of FIG. 4 (e.g., when the second memory board 404B of FIGS. 6A and/or 6B is inserted into the second slot 410B). In some examples, portions of the signal pins 414 that contact the respective pin contact portions 622 have a first dimension (e.g., a first width) along the Y-axis 513, and the pin contact portions 622 have a second dimension (e.g., a second width) along the X-axis 512, where the second dimension is greater than the first dimension. As a result, adjacent ones of the signal pins 414 are spaced apart by a first distance along the Y-axis 513, and adjacent ones of the pin contact portions 622 are spaced apart by a second distance along the Y-axis 513, where the second distance is less than the first distance. As a result, a capacitance between the adjacent ones of the signal pins 414 (e.g., on a same side or opposite sides 702, 704 of the second support block 416B) can be increased when the signal pins 414 are electrically coupled to the respective pin contact portions 622 (e.g., compared to when the signal pins 414 do not contact the pin contact portions 622 and/or when the pin contact portions 622 are not conductive). In such examples, increasing the capacitance between the adjacent signal pins 414 can reduce crosstalk between signals travelling through the signal pins 414.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve reliability of electrical signals propagating across a circuit board. Disclosed examples include an example housing proximate a surface of a first circuit board and including a slot to receive a memory board. An example pin array (e.g., including signal pins and ground pins) extends through at least a portion of the housing. The ground pins of the pin array are fixedly coupled to the surface of the first circuit board, and the signal pins of the pin array are movable (e.g., translatable and/or flexible) relative to the surface. When no circuit board is inserted into the slot, the signal pins are spaced apart and/or electrically isolated from the surface of the first circuit board. As a result, the signal pins do not impede or otherwise interfere with electrical signals travelling through conductive traces on the first circuit board when no circuit board is inserted into the slot. Conversely, when a second circuit board (e.g., a memory board) is inserted into the slot, the signal pins are urged into contact with respective conductive pads on the surface of the first circuit board to electrically couple the second circuit board to the first circuit board. In some examples, a capacitance between the signal pins may increase (e.g., as a result of a reduction in distance between the signal pins) when the second circuit board is inserted into the slot. In some examples, increasing the capacitance between the signal pins can reduce crosstalk between electrical signals propagating through the signal pins. By reducing crosstalk, impedance, and/or other adverse signaling effects, disclosed systems, apparatus, articles of manufacture, and methods improve the efficiency of using a computing device by improving reliability of electrical signals propagating through the computing device. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to improve reliability of electrical signals across a circuit board are disclosed herein. Further examples and combinations thereof include the following:

Example 1 includes an apparatus comprising a housing defining a slot to receive a first circuit board, the housing proximate a surface of a second circuit board, and a conductive pin in the housing, the conductive pin spaced apart from a conductive pad on the surface of the second circuit board when no circuit board is inserted into the slot, the conductive pin to be urged into contact with the conductive pad when the first circuit board is inserted into the slot, the conductive pin to electrically couple the first circuit board to the conductive pad.

Example 2 includes any preceding clause(s) of example 1, wherein the conductive pin includes first and second portions extending into the slot, the first portion to contact a first surface of the first circuit board and the second portion to contact a second surface of the first circuit board when the first circuit board is inserted into the slot.

Example 3 includes any preceding clause(s) of any one or more of examples 1-2, wherein the conductive pin includes a U-shaped bend between the first and second portions, the U-shaped bend proximate the conductive pad.

Example 4 includes any preceding clause(s) of any one or more of examples 1-3, wherein the conductive pin includes one or more second bends between the first portion and the second portion.

Example 5 includes any preceding clause(s) of any one or more of examples 1-4, further including a support block within the housing, the support block movable with respect to the housing, a first surface of the support block to contact the first circuit board and a second surface of the support block to contact the conductive pin when the first circuit board is inserted into the slot.

Example 6 includes any preceding clause(s) of any one or more of examples 1-5, wherein the first surface corresponds to a non-conductive portion of the support block and the second surface corresponds to a conductive portion of the support block.

Example 7 includes any preceding clause(s) of any one or more of examples 1-6, wherein the conductive portion of the support block includes a first conductive material corresponding to a second conductive material of the conductive pin.

Example 8 includes any preceding clause(s) of any one or more of examples 1-7, wherein the conductive pin is a first conductive pin, the conductive portion is a first conductive portion, and the support block includes a second conductive portion to contact a second conductive pin in the housing when the first circuit board is inserted into the slot, the first conductive pin and the second conductive pin spaced apart by a first distance, the first conductive portion and the second conductive portion spaced apart by a second distance less than the first distance.

Example 9 includes any preceding clause(s) of any one or more of examples 1-8, wherein the first circuit board is a dual in-line memory module.

Example 10 includes any preceding clause(s) of any one or more of examples 1-9, wherein the housing is a first housing, the slot is a first slot, the conductive pin is a first conductive pin, the conductive pad is a first conductive pad, and further including a second conductive pad on the surface of the second circuit board, the second conductive pad electrically coupled to the first conductive pad via a conductive trace, a second housing proximate the second conductive pad, the second housing defining a second slot to receive a third circuit board, and a second conductive pin in the second housing, the second conductive pin spaced apart from the second conductive pad when no circuit board is inserted into the second slot, the second conductive pin to be urged into contact with the second conductive pad when the third circuit board is inserted into the second slot, the first conductive pin electrically coupled to the second conductive pin when the first circuit board is inserted into the first slot and the third circuit board is inserted into the second slot.

Example 11 includes any preceding clause(s) of any one or more of examples 1-10, wherein the conductive pin is a first conductive pin, the conductive pad is a first conductive pad, and further including a second conductive pad on the surface of the second circuit board, the second conductive pad electrically isolated from the first conductive pad, and a second conductive pin in the housing and spaced apart from the second conductive pad and spaced apart from the first conductive pin by a first distance when no circuit board is inserted into the slot, the second conductive pin to be urged into contact with the second conductive pad and spaced apart from the first conductive pin by a second distance when the first circuit board is inserted into the slot, the second distance less than the first distance.

Example 12 includes an apparatus comprising a circuit board, and a pin array coupled to a surface of the circuit board, the pin array associated with a slot to receive a memory board, the pin array including a ground pin fixedly coupled to the surface, and a signal pin movable relative to the surface, the signal pin electrically isolated from the surface when no memory board is inserted into the slot, the signal pin urged into contact with the surface when the memory board is inserted into the slot.

Example 13 includes any preceding clause(s) of example 12, wherein the signal pin is a first signal pin in a first row of the pin array, and the pin array further includes a second signal pin in a second row of the pin array, the first signal pin and the second signal pin spaced apart by a first distance when no memory board is inserted into the slot, the first signal pin and the second signal pin spaced apart by a second distance when the memory board is inserted into the slot, the second distance less than the first distance.

Example 14 includes any preceding clause(s) of any one or more of examples 12-13, wherein a first portion of the first signal pin overlaps with a second portion of the second signal pin when the memory board is inserted into the slot.

Example 15 includes any preceding clause(s) of any one or more of examples 12-14, wherein the signal pin is a first signal pin in a first row of the pin array, and further including a second signal pin in the first row of the pin array, the second signal pin spaced apart from the first signal pin by a first distance, and a support block positioned in the pin array, the support block including a first conductive portion to contact the first signal pin, and a second conductive portion to contact the second signal pin, the second conductive portion spaced apart from the first conductive portion by a second distance less than the first distance.

Example 16 includes any preceding clause(s) of any one or more of examples 12-15, wherein the signal pin includes a first curved portion to contact a first surface of the memory board and a second curved portion to contact a second surface of the memory board when the memory board is inserted into the slot, the second surface different from the first surface.

Example 17 includes any preceding clause(s) of any one or more of examples 12-16, wherein the signal pin includes a third curved portion between the first curved portion and the second curved portion, the third curved portion to contact a conductive pad on the surface of the circuit board when the memory board is inserted into the slot.

Example 18 includes any preceding clause(s) of any one or more of examples 12-17, wherein the conductive pad is a first conductive pad, the pin array is a first pin array, and further including a conductive via extending through the circuit board, and a second conductive pad on the surface of the circuit board, the second conductive pad associated with a second pin array, the first conductive pad electrically coupled to the second conductive pad and to the conductive via.

Example 19 includes an apparatus comprising a circuit board, a first array of pins to electrically contact a first memory board inserted into a first slot of a first housing, the first housing supported on the circuit board, a second array of pins to electrically contact a second memory board inserted into a second slot of a second housing, the second housing supported on the circuit board, and a trace extending along the circuit board between a first contact pad and a second contact pad, the first contact pad to be in contact with a first pin in the first array of pins when the first memory board is inserted into the first slot, the first contact pad to be spaced apart from the first pin when the first slot is empty.

Example 20 includes any preceding clause(s) of example 19, wherein the first array of pins further includes a ground pin, a first portion of the ground pin extending into the first slot, a second portion of the ground pin fixedly coupled to the circuit board.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a housing defining a slot to receive a first circuit board, the housing proximate a surface of a second circuit board; and
a conductive pin in the housing, the conductive pin spaced apart from a conductive pad on the surface of the second circuit board when no circuit board is inserted into the slot, the conductive pin to be urged into contact with the conductive pad when the first circuit board is inserted into the slot, the conductive pin to electrically couple the first circuit board to the conductive pad.

2. The apparatus of claim 1, wherein the conductive pin includes first and second portions extending into the slot, the first portion to contact a first surface of the first circuit board and the second portion to contact a second surface of the first circuit board when the first circuit board is inserted into the slot.

3. The apparatus of claim 2, wherein the conductive pin includes a U-shaped bend between the first and second portions, the U-shaped bend proximate the conductive pad.

4. The apparatus of claim 3, wherein the conductive pin includes one or more second bends between the first portion and the second portion.

5. The apparatus of claim 1, further including a support block within the housing, the support block movable with respect to the housing, a first surface of the support block to contact the first circuit board and a second surface of the support block to contact the conductive pin when the first circuit board is inserted into the slot.

6. The apparatus of claim 5, wherein the first surface corresponds to a non-conductive portion of the support block and the second surface corresponds to a conductive portion of the support block.

7. The apparatus of claim 6, wherein the conductive portion of the support block includes a first conductive material corresponding to a second conductive material of the conductive pin.

8. The apparatus of claim 6, wherein the conductive pin is a first conductive pin, the conductive portion is a first conductive portion, and the support block includes a second conductive portion to contact a second conductive pin in the housing when the first circuit board is inserted into the slot, the first conductive pin and the second conductive pin spaced apart by a first distance, the first conductive portion and the second conductive portion spaced apart by a second distance less than the first distance.

9. The apparatus of claim 1, wherein the first circuit board is a dual in-line memory module.

10. The apparatus of claim 1, wherein the housing is a first housing, the slot is a first slot, the conductive pin is a first conductive pin, the conductive pad is a first conductive pad, and further including:
a second conductive pad on the surface of the second circuit board, the second conductive pad electrically coupled to the first conductive pad via a conductive trace;
a second housing proximate the second conductive pad, the second housing defining a second slot to receive a third circuit board; and
a second conductive pin in the second housing, the second conductive pin spaced apart from the second conductive pad when no circuit board is inserted into the second slot, the second conductive pin to be urged into contact with the second conductive pad when the third circuit board is inserted into the second slot, the first conductive pin electrically coupled to the second conductive pin when the first circuit board is inserted into the first slot and the third circuit board is inserted into the second slot.

11. The apparatus of claim 1, wherein the conductive pin is a first conductive pin, the conductive pad is a first conductive pad, and further including:
a second conductive pad on the surface of the second circuit board, the second conductive pad electrically isolated from the first conductive pad; and
a second conductive pin in the housing and spaced apart from the second conductive pad and spaced apart from the first conductive pin by a first distance when no circuit board is inserted into the slot, the second conductive pin to be urged into contact with the second conductive pad and spaced apart from the first conductive pin by a second distance when the first circuit board is inserted into the slot, the second distance less than the first distance.

12. An apparatus comprising:
a circuit board; and
a pin array coupled to a surface of the circuit board, the pin array associated with a slot to receive a memory board, the pin array including:
a ground pin fixedly coupled to the surface; and
a signal pin movable relative to the surface, the signal pin electrically isolated from the surface when no memory board is inserted into the slot, the signal pin urged into contact with the surface when the memory board is inserted into the slot.

13. The apparatus of claim 12, wherein the signal pin is a first signal pin in a first row of the pin array, and the pin array further includes a second signal pin in a second row of the pin array, the first signal pin and the second signal pin spaced apart by a first distance when no memory board is inserted into the slot, the first signal pin and the second signal pin spaced apart by a second distance when the memory board is inserted into the slot, the second distance less than the first distance.

14. The apparatus of claim 13, wherein a first portion of the first signal pin overlaps with a second portion of the second signal pin when the memory board is inserted into the slot.

15. The apparatus of claim 12, wherein the signal pin is a first signal pin in a first row of the pin array, and further including:
a second signal pin in the first row of the pin array, the second signal pin spaced apart from the first signal pin by a first distance; and
a support block positioned in the pin array, the support block including:
a first conductive portion to contact the first signal pin; and
a second conductive portion to contact the second signal pin,
the second conductive portion spaced apart from the first conductive portion by a second distance less than the first distance.

16. The apparatus of claim 12, wherein the signal pin includes a first curved portion to contact a first surface of the memory board and a second curved portion to contact a second surface of the memory board when the memory board is inserted into the slot, the second surface different from the first surface.

17. The apparatus of claim 16, wherein the signal pin includes a third curved portion between the first curved portion and the second curved portion, the third curved portion to contact a conductive pad on the surface of the circuit board when the memory board is inserted into the slot.

18. The apparatus of claim 17, wherein the conductive pad is a first conductive pad, the pin array is a first pin array, and further including:
a conductive via extending through the circuit board; and
a second conductive pad on the surface of the circuit board, the second conductive pad associated with a second pin array, the first conductive pad electrically coupled to the second conductive pad and to the conductive via.

19. An apparatus comprising:
a circuit board;
a first array of pins to electrically contact a first memory board inserted into a first slot of a first housing, the first housing supported on the circuit board;
a second array of pins to electrically contact a second memory board inserted into a second slot of a second housing, the second housing supported on the circuit board; and
a trace extending along the circuit board between a first contact pad and a second contact pad, the first contact pad to be in contact with a first pin in the first array of pins when the first memory board is inserted into the first slot, the first contact pad to be spaced apart from the first pin when the first slot is empty.

20. The apparatus of claim 19, wherein the first array of pins further includes a ground pin, a first portion of the ground pin extending into the first slot, a second portion of the ground pin fixedly coupled to the circuit board.
